(19) United States
(12) Patent Application Publication
(10) Pub. No.: US 2017/0054947 A1
(43) Pub. Date: Feb. 23, 2017

(54) SYSTEM AND METHOD FOR MONITORING CONDITION OF WORKSITE

(71) Applicant: Caterpillar Inc., Peoria, IL (US)

(72) Inventor: David M. Longanbach, Peoria, IL (US)

(73) Assignee: Caterpillar Inc., Peoria, IL (US)

(21) Appl. No.: 14/829,690

(22) Filed: Aug. 19, 2015

(51) Int. Cl. H04N 7/18

(52) U.S. Cl. CPC H04N 7/181

(57) ABSTRACT

A system for monitoring a condition of a worksite is provided. The system includes an image capturing module configured to generate an image of the worksite. The system also includes a ground property determination module. The ground property determination module is coupled to the image capturing module. The ground property determination module is configured to receive the image of the worksite. The ground property determination module is also configured to determine one or more ground parameters associated with the worksite based on the image.

### TECHNICAL FIELD

The present disclosure relates to a system and method for monitoring a condition of a worksite, and more particularly to the system and method for monitoring the condition of the worksite using image capturing modules.

### BACKGROUND

Machines operating on a worksite may be subjected to wear and tear due to ground properties and conditions at the worksite. In some examples, components of the machines that are in contact with a ground surface of the worksite, such as undercarriage components, ground engaging tools, and the like, may be subjected to wear, tear, and other conditions that affect the durability of the machine components. External conditions such as ambient temperature and work done on the ground may affect the ground properties at the worksite. Changes in the ground properties may sometimes affect the machine components, thereby impacting overall system productivity and efficiency.

U.S. Published Application Number 2012/0029869 describes a method for assessing a ground area for suitability as a landing zone or taxi area for aircraft is provided. Three-dimensional data for the ground area in a plurality of measurement cycles in a 3D sensor is produced. The measured-value density of the three-dimensional data and also of at least one further statistical property of the three-dimensional data is determined. A measure of the local roughness of the ground area is produced based on the measured-value density and the at least one further statistical property. The individual area elements of the ground area are classified on the basis of the roughness values produced according to the degree of suitability of said area elements as a landing area or taxi area.

### SUMMARY OF THE DISCLOSURE

In one aspect of the present disclosure, a system for monitoring a condition of a worksite is provided. The system includes an image capturing module configured to generate an image of the worksite. The system also includes a ground property determination module. The ground property determination module is coupled to the image capturing module. The ground property determination module is configured to receive the image of the worksite. The ground property determination module is also configured to determine one or more ground parameters associated with the worksite based on the image.

In another aspect of the present disclosure, a method for monitoring a condition of a worksite is provided. The method includes capturing an image of a ground surface at a worksite. The method also includes receiving the image by a ground property determination module. The method further includes determining, by the ground property determination module, one or more ground parameters associated with the worksite based on the received image.

Other features and aspects of this disclosure will be apparent from the following description and the accompanying drawings.

### BRIEF DESCRIPTION OF THE DRAWINGS

FIG. 1 is a perspective view of an exemplary worksite having a plurality of machines, according to one embodiment of the present disclosure;

FIG. 2 is a block diagram of a system for monitoring a condition of the worksite, according to one embodiment of the present disclosure; and

FIG. 3 is a flowchart for a method of monitoring the condition of the worksite.

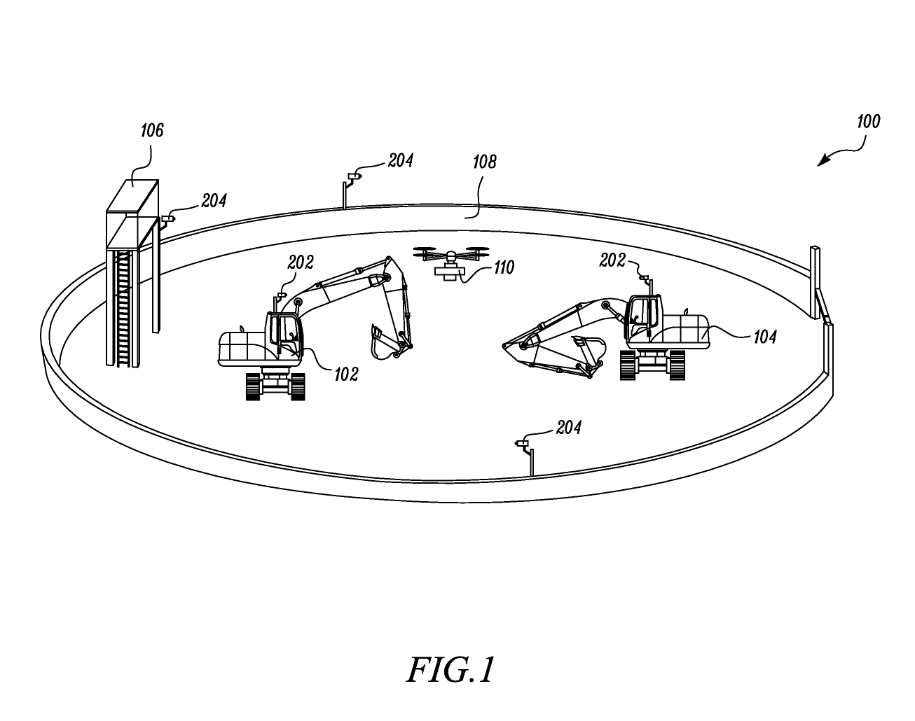

### DETAILED DESCRIPTION

Wherever possible, the same reference numbers will be used throughout the drawings to refer to the same or the like parts. FIG. 1 is a schematic view of an exemplary worksite 100. A number of different machines 102, 104 may operate on the worksite 100 to perform various operations, such as, loading and unloading of payload, earth moving, excavation, and the like.

Although the machines 102, 104 described in connection with this disclosure are embodied as excavators, alternatively the machines 102, 104 may include any other type of same or different machines, without any limitation. Further, for the purpose of simplicity only two machines 102, 104 are deployed at the worksite 100 in the accompanying figures. The number of machines operating at the worksite 100 may vary based on the application. The machines 102, 104 may be embodied as remotely controlled vehicles that are controlled by operators seated at a remote operator station (not shown). In another example, the machines 102, 104 may be driven by operators seated within operator cabins of the respective machines 102, 104. In yet another example, the machines 102, 104 may be semi-autonomous or full autonomous.

Over a period of time, a ground surface at the worksite 100 may undergo changes. More particularly, one or more ground parameters of the ground surface at the worksite 100 may undergo changes due to various factors. The one or more ground parameters may include a soil density, a surface hardness, and a moisture content of soil, or a combination thereof without any limitations. It should be noted that the ground parameters listed above are exemplary in nature. A number of other ground parameters (not listed herein) may be associated with the ground surface, without limiting the scope of the present disclosure.

In one example, the change in the one or more ground parameters may be due to environmental conditions prevailing at the worksite 100. In another example, the change in the ground parameters may be caused due to operations that are performed by the machines 102, 104 on the worksite 100. Alternatively, the change in the ground parameters may be caused due to reasons other those described herein. Changes in the ground parameters at the worksite 100 may affect components of the machines 102, 104 operating thereon. In some situations, the machine components of the machine 102, 104 may be subject to wear and tear due to changes in the ground parameters. More particularly, the machine components contacting the ground surface, such as undercarriage components, ground engaging tools, and the like, may be subjected to wear and tear. In some examples, the machine components may be subjected to normal wear, accelerated wear, and other conditions that affect the durability of the respective machine components.

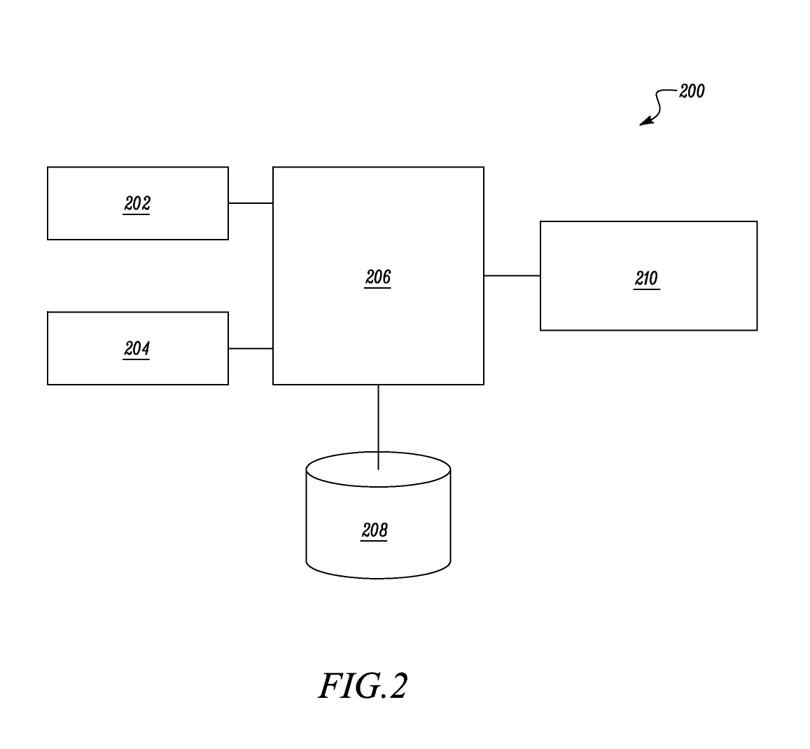

The present disclosure relates to a system 200 for monitoring a condition of the worksite 100. More particularly, the system 200 is configured to determine the ground parameters or the changes in the ground parameters. Referring to FIG. 2, the system 200 includes an image capturing module. A pair of image capturing modules 202, 204 is shown in the accompanying figures. The image capturing module 202, 204 is configured to generate an image of the worksite 100. More particularly, the image capturing module 202, 204 is configured to capture the image of a ground surface at the worksite 100. In one example, in order to capture the image of recently worked ground surface, the image is captured after a particular machine 102, 104 operating at the worksite 100 has performed work on the ground. The image capturing module 202, 204 may include any known image capturing device, such as a still camera, a camcorder, a video recorder, and the like, without any limitations. Further, the image capturing module 202, 204 may also embody digital cameras that are wireless and mobile in operation.

The image capturing module 202 is associated with the machine 102, 104 operating on the worksite 100. The image capturing module 202 may be provided on-board the number of machines 102, 104 operating on the worksite 100. The image capturing module 202 may include a back up camera that is provided on the respective machines 102, 104 for safety purposes. Alternatively, the image capturing module 202 may include cameras that are specifically deployed on the machines 102, 104 to determine ground properties and conditions. In various examples, the image capturing module 202 may be provided on top of the operator cabin of the machines 102, 104. Alternatively, the image capturing module 202 may be provided on a front end of the respective machines 102, 104. For example, the image capturing module 202 may be provided on an engine hood of the machine 102, 104.

Further, the image capturing module 202 may be provided at a rear section of the respective machine 102, 104 such that a lens of the image capturing module 202 is focused on the ground surface. The image capturing module 202 provided at the rear section of the machine 102, 104 may be configured to generate an image of the worksite 100 behind the machines 102, 104 after the respective machine 102, 104 performs work on the worksite 100.

The image capturing module 204 may be present on the worksite 100. For example, the image capturing module 204 may be provided at a fixed location on the worksite 100. In one example, the image capturing module 204 may be present at a base station 106 on the worksite 100. Alternatively, the image capturing module 204 may be provided at boundary walls 108 of the worksite 100. In another exemplary embodiment, the image capturing module 204 may include mobile sensors (not shown) and/or aerial vehicles 110 (see FIG. 1) deployed at the worksite 100. As per requirements, the aerial vehicles 110 may be deployed at the worksite 100 to take visual images or videos of the worksite 100. In one exemplary embodiment, the aerial vehicle 110 may embody a drone.

It should be noted that the functionality of the image capturing module 202, 204 may be integrated with that of various image capturing devices present on-board the machines 102, 104 or the worksite 100. For example, the system 200 may be configured to utilize the image capturing devices that are already existing on the machines 102, 104 or the worksite 100. Alternatively, the image capturing module 202, 204 may embody a dedicated imaging device associated with the machine 102, 104 or the worksite 100. Location and number of the image capturing modules 202, 204 may vary based on the system requirements.

Referring to the accompanying figures, the system 200 includes a ground property determination module 206. The ground property determination module 206 is communicably coupled to the image capturing modules 202, 204. The ground property determination module 206 is configured to receive image of the ground surface at the worksite 100 from the image capturing modules 202, 204 provided on the machines 102, 104 or at the worksite 100. Further, the ground property determination module 206 assimilates the images received from multiple image capturing modules 202, 204.

The ground property determination module 206 disclosed herein is configured to analyze the image received from the image capturing modules 202, 204. Based on the analysis of the image, the ground property determination module 206 is configured to determine the one or more ground parameters associated with the ground surface at the worksite 100 on a real time or periodic basis. For example, the ground property determination module 206 may determine the ground parameters such as the soil density, the surface hardness, and the moisture content of soil of the ground surface at the worksite 100. In other examples, the ground property determination module 206 may determine ground parameters other than those listed above, without limiting the scope of the present disclosure. The ground property determination module 206 may also determine other ground parameters without limiting the scope of the present disclosure. The ground property determination module 206 may make use of any known image processing methods in order to analyze the images of the ground surface.

The ground property determination module 206 associated with the system 200 is configured to determine a change in the one or more ground parameters. These changes in the ground parameters may be caused due to various factors such as environmental conditions, the machine operations on the worksite 100, and so on. More particularly, the ground property determination module 206 is configured to compare the one or more ground parameters of the worksite 100 determined from the images with a predetermined threshold. The predetermined threshold may correspond to standard ground parameters of the ground surface at the worksite 100. In one example, the predetermined threshold of the one or more ground parameters may be retrieved from a database 208.

The database 208 may be communicably coupled to the ground property determination module 206. The database 208 may store the predetermined thresholds corresponding to the one or more ground parameters. Based on the comparison, the ground property determination module 206 is configured to determine the change in the one or more ground parameters. In other embodiments, the images captured by the image capturing modules 202, 204 and/or the images analyzed by the ground property determination module 206 may be stored in the database 208 and subsequently retrieved therefrom in order to perform a historical analysis of the ground parameters.

Optionally or additionally the ground property determination module 206 is configured to predict a wear rate associated with each of the machines 102, 104 operating on the worksite 100 on a real time basis, based on the determination the ground parameters. More particularly, the change in the one or more ground properties may be utilized to predict the amount of wear the machine components, such as the undercarriage components or the ground engaging tools of the machines 102, 104, based on the determined ground parameters that the machine 102, 104 work on. The ground property determination module 206 may include algorithms that process the data pertaining to the change in the ground parameters to effectively predict the wear rate of one or more machine components.

A notification indicative of the predicted wear rate may be provided to a personnel, such as an expert, via an output module 210. The output module 210 is communicably coupled to the ground property determination module 206 in a wired or wireless manner. The output module 210 is configured to provide the indication to the expert of the predicted wear rate.

The output module 210 may embody a visual output or an audio output. In one example, in case of an audible output, an alarm generated by the output module 210 may notify the operator of the predicted wear rate. In another example, wherein the output module 210 is embodied as a visual output, the output module 210 may include any one of a digital display device, a Liquid Crystal Display (LCD) device, a Light-Emitting Diode (LED) device, a cathode ray tube (CRT) monitor, a touchscreen device, or any other display device known in the art. In one example, the output module 210 may notify the expert regarding the predicted wear rate through a text message. In a situation wherein the output module 210 is embodied as the audio output, an audio clip may be heard; thereby notifying the personnel regarding the predicted wear rate. It should be noted that the output module 210 may include any other means other than those listed above.

In another exemplary embodiment, the images received by the ground property determination module 206 may be directly transmitted to the database 208. As per requirements, the images corresponding to the ground surface at the worksite 100 may be later retrieved from the database 208 by the expert. The expert may analyze and process the images stored in the database 208 to determine the changes in the one or more ground parameters associated with the worksite 100. The expert may further process the data corresponding to the changes in the one or more ground parameters to predict the wear rate of the machine components.

The results of the predicted wear rates as analyzed and received from the ground property determination module 206 or from the expert may be updated to various systems and databases without any limitation. For example, the results may be updated by maintenance planning software (not shown) so that the results of the predicted wear rate may assist in scheduling of maintenance activities on the machines 102, 104 operating on the worksite 100. Further, the ground property determination module 206 may also store, retrieve, and process historical data related to the worksite 100 from a database (not shown). The historical data can be processed on the machines 102, 104, on the worksite 100, or offsite.

The ground property determination module 206 may embody a single microprocessor or multiple microprocessors for receiving signals from components of the system 200. Numerous commercially available microprocessors may be configured to perform the functions of the ground property determination module 206. A person of ordinary skill in the art will appreciate that the ground property determination module 206 may additionally include other components and may also perform other functions not described herein. Further, the system 200 may include additional modules (not shown) in order to implement the described functionality of the system 200.

### INDUSTRIAL APPLICABILITY

The present disclosure relates to the system 200 for monitoring conditions of the worksite 100. The system 200 analyzes visual data or images that are provided by various image capturing modules 202, 204 provided on the machines 102, 104 or at the worksite 100. The images can be processed by the ground property determination module 206 or the experts who are trained to identify different ground properties and conditions to predict wear rates, and also to determine the effect on wear rates and update other systems as needed.

The system 200 disclosed herein is reliable in operation. Further, as the ground properties and conditions dynamically change, the system 200 allows for assimilation of images from various image capturing modules 202, 204 which in turn can be used to better predict wear rates in real time. In one example, the system 200 makes use of existing image capturing modules 202, 204 present on the machines 102, 104 or at the worksite 100, and hence presents a cost effective solution.

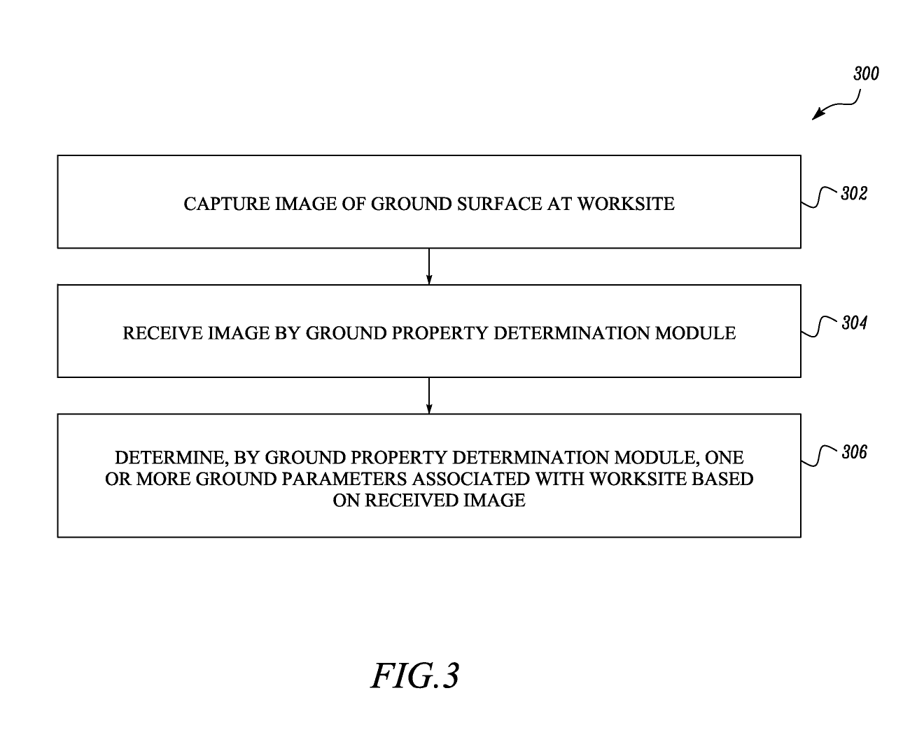

FIG. 3 is a flowchart for a method 300 of monitoring the condition of the worksite 100. At step 302, the image capturing modules 202, 204 capture the images of the ground surface at the worksite 100. The image capturing is performed after the respective machine 102, 104 at the worksite 100 has performed work on the ground surface at the worksite 100 to capture the image of recently worked ground surface.

At step 304, the image of the ground surface is received by the ground property determination module 206. The images from the number of image capturing modules 202, 204 are assimilated by the ground property determination module 206. At step 306, the ground property determination module 206 determines one or more ground parameters associated with the worksite 100 based on the images received from the image capturing modules 202, 204. More particularly, the images are analyzed to determine the ground properties of the ground surface. The ground parameters include at least one of the soil density, the surface hardness, and the moisture content of soil. The ground property determination module 206 disclosed herein also has the capability to determine and analyze ground parameters other than those listed above, without any limitations.

Further, the determined ground properties are compared with predetermined thresholds to determine the change in the one or more ground parameters based, at least in part, on environmental conditions and machine operations. Based on the determination of the change in the ground properties, the wear rate associated with each of the machines 102, 104 and its components are predicted. In one example, the notification of the predicted wear rate is triggered and updated to various systems that may require such data.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for monitoring a condition of a worksite, the system comprising:
an image capturing module configured to generate an image of the worksite; and
a ground property determination module coupled to the image capturing module, the ground property determination module configured to:
receive the image of the worksite; and
determine one or more ground parameters associated with the worksite based on the image.

2. The system of claim 1, wherein the image capturing module is provided on a plurality of machines at the worksite.

3. The system of claim 2, wherein the image capturing module is configured to generate an image of the worksite behind the plurality of machines after the plurality of machines perform work on the worksite.

4. The system of claim 1, wherein the image capturing module is provided on the worksite at a fixed location.

5. The system of claim 1, wherein the image capturing module includes at least one of a mobile sensor and an aerial vehicle.

6. The system of claim 1, wherein the ground property determination module is further configured to assimilate the image from a plurality of image capturing modules.

7. The system of claim 1, wherein the ground property determination module is further configured to analyze the image for determining the one or more ground parameters.

8. The system of claim 1, wherein the ground property determination module is further configured to determine a change in the one or more ground parameters based, at least in part, on environmental conditions and machine operations.

9. The system of claim 1, wherein the one or more ground parameters include at least one of a soil density, a surface hardness, and a moisture content of soil.

10. The system of claim 1, wherein the ground property determination module is further configured to predict a wear rate associated with each of a plurality of machines associated with the worksite based on the determination.

11. The system of claim 1 further comprising an output module coupled to the ground property determination module.

12. The system of claim 11, wherein the ground property determination module is further configured to trigger a notification of the predicted wear rate.

13. A method for monitoring a condition of a worksite, the method comprising:
capturing an image of a ground surface at a worksite;
receiving the image by a ground property determination module; and
determining, by the ground property determination module, one or more ground parameters associated with the worksite based on the received image.

14. The method of claim 13 further comprising:
assimilating the image from a plurality of image capturing modules.

15. The method of claim 13 further comprising:
analyzing the image for determining the one or more ground parameters.

16. The method of claim 13 further comprising:
determining a change in the one or more ground parameters based, at least in part, on environmental conditions and machine operations.

17. The method of claim 13, wherein the one or more ground parameters include at least one of a soil density, a surface hardness, and a moisture content of soil.

18. The method of claim 13 further comprising:
predicting a wear rate associated with each of a plurality of machines associated with the worksite based on the determination.

19. The method of claim 13 further comprising:
triggering a notification of the predicted wear rate.

20. The method of claim 13, wherein the step of capturing the image is performed immediately after a machine at the worksite has performed work on the ground surface at the worksite to capture an image of recently worked ground surface.
